(19) United States
(12) Patent Application Publication
(10) Pub. No.: US 2018/0264738 A1
(43) Pub. Date: Sep. 20, 2018

(54) THREE-DIMENSIONAL MODELING APPARATUS, NON-TRANSITORY COMPUTER READABLE MEDIUM STORING THREE-DIMENSIONAL MODELING PROGRAM, AND NON-TRANSITORY COMPUTER READABLE MEDIUM STORING THREE-DIMENSIONAL MODELING DATA GENERATION PROGRAM

(71) Applicant: FUJI XEROX CO., LTD., Tokyo (JP)

(72) Inventors: Naoki HIJI, Kanagawa (JP); Torahiko KANDA, Kanagawa (JP)

(73) Assignee: FUJI XEROX CO., LTD., Tokyo (JP)

(21) Appl. No.: 15/903,230

(22) Filed: Feb. 23, 2018

(30) Foreign Application Priority Data
Mar. 15, 2017 (JP) 2017-049850

(51) Int. Cl. B29C 64/393; B33Y 50/02; B33Y 30/00; B29C 64/209

(52) U.S. Cl. CPC B29C 64/393; B29C 64/209; B33Y 30/00; B33Y 50/02

(57) ABSTRACT

A three-dimensional modeling apparatus includes: multiple discharge heads that is used for model processing of a three-dimensional model, and that discharges multiple model materials with different attributes; and a controller that controls the multiple discharge heads so that a probability of discharge of a model material with a predetermined attribute is higher at a position closer to the lateral side of the three-dimensional model.

### CROSS-REFERENCE TO RELATED APPLICATIONS

This application is based on and claims priority under 35 USC 119 from Japanese Patent Application No. 2017-049850 filed Mar. 15, 2017.

### BACKGROUND

### Technical Field

The present invention relates to a three-dimensional modeling apparatus, a non-transitory computer readable medium storing a three-dimensional modeling program, and a non-transitory computer readable medium storing a three-dimensional modeling data generation program.

### SUMMARY

According to an aspect of the invention, there is provided a three-dimensional modeling apparatus including: multiple discharge heads that is used for model processing of a three-dimensional model, and that discharges multiple model materials with different attributes; and a controller that controls the multiple discharge heads so that a probability of discharge of a model material with a predetermined attribute is higher at a position closer to the lateral side of the three-dimensional model.

### BRIEF DESCRIPTION OF THE DRAWINGS

Exemplary embodiments of the present invention will be described in detail based on the following figures, wherein:

FIG. 1 is a block diagram of a three-dimensional modeling apparatus;

FIG. 2 is a side view of a three-dimensional modeling apparatus;

FIG. 3 is a flowchart of a three-dimensional modeling program;

FIG. 4 is a table for explaining setting of color information;

FIG. 5 is a diagram illustrating a color arrangement example and a frequency of appearance of each color in a lateral side section of a three-dimensional model;

FIG. 6 is a diagram illustrating a color arrangement example and a frequency of appearance of each color in a lateral side section of a three-dimensional model according to a variation;

FIG. 7 is a diagram illustrating a color arrangement example and a frequency of appearance of each color in a lateral side section of a three-dimensional model according to a variation; and

FIG. 8 is a table illustrating an example of table data for correction color appearance probability.

### DETAILED DESCRIPTION

Hereinafter, an exemplary embodiment for carrying out the present invention will be described in detail with reference to the drawings.

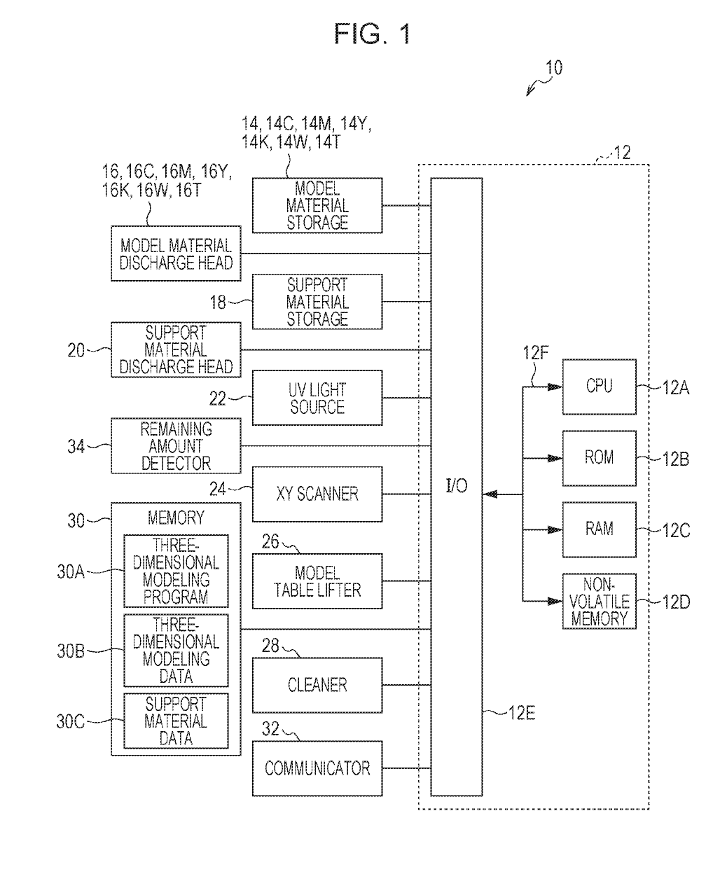

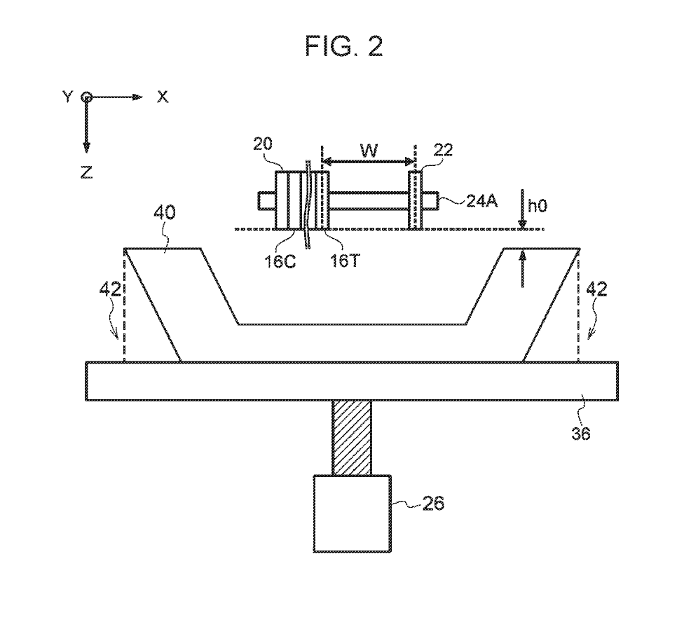

First, the configuration of a three-dimensional modeling apparatus 10 according to this exemplary embodiment will be described with reference to FIG. 1 and FIG. 2. It is to be noted that in the following description, cyan color, magenta color, yellow color, black color, white color, and a transparent color with no tint are denoted by C, M, Y, K, W, and T, respectively, and when components have to be distinguished by color, the end of the symbol of each component is labeled with a color symbol (C, M, Y, K, W, T) corresponding to the color. Also, when components are collectively called without being distinguished by color, the color symbol at the end of each symbol is omitted in the description.

As illustrated in FIG. 1, a three-dimensional modeling apparatus 10 includes a controller 12, model material storages 14C, 14M, 14Y, 14K, 14W, 14T, model material discharge heads 16C, 16M, 16Y, 16K, 16W, 16T, and a support material storage 18. In addition, the three-dimensional modeling apparatus 10 includes a support material discharge head 20, an ultra violet (UV) light source 22, an XY scanner 24, a model table lifter 26, a cleaner 28, a memory 30, a communicator 32, and a remaining amount detector 34. It is to be noted that the model material discharge heads 16C, 16M, 16Y, 16K, 16W are an example of a first discharge head. The model material discharge head 16T is an example of a second discharge head.

The controller 12 includes a central processing unit (CPU) 12A, a read only memory (ROM) 12B, a random access memory (RAM) 12C, a non-volatile memory 12D, and an input/output (I/O) interface 12E. The CPU 12A, the ROM 12B, the RAM 12C, the non-volatile memory 12D, and the I/O 12E are connected to each other via a bus 12F.

Also, the I/O 12E is connected to the model material storage 14, the model material discharge head 16, the support material storage 18, the support material discharge head 20, the UV light source 22, and the XY scanner 24. Furthermore, the I/O 12E is connected to the model table lifter 26, the cleaner 28, the memory 30, the communicator 32, and the remaining amount detector 34. It is to be noted that the CPU 12A is an example of a controller.

The model material storage 14 stores model materials for creating a three-dimensional model. In addition, the model material storage 14 stores a model material corresponding to each of the colors. The model material is composed of a UV-curing resin or the like that has a property of being cured when irradiated with UV light, that is, ultraviolet light.

The model material discharge head 16 discharges a model material of a corresponding color by ink-jet in accordance with a command from the CPU 12A, the model material being supplied from the model material storage 14.

The support material storage 18 stores a support material for supporting or protecting a three-dimensional model. The support material is used for the purpose of supporting an overhanging portion (a projecting portion) of a three-dimensional model until the three-dimensional model is completed, and is removed after the completion of the three-dimensional model. For instance, when a three-dimensional model has a nearly vertical surface like a cube, the support material is also used for the purpose of avoiding and protecting against liquid dripping on the surface. In addition, the support material is used for the purpose of covering and protecting the model material in order to avoid deterioration of the three-dimensional model due to irradiation of UV light. Similarly to the model material, the support material is composed of a UV-curing resin or the like that has a property of being cured when irradiated with UV light.

The support material discharge head 20 discharges a support material by ink-jet in accordance with a command from the CPU 12A, the support material being supplied from the support material storage 18.

Each of the model material discharge head 16 and the support material discharge head 20 includes plural nozzles, and uses a piezoelectric type discharge head that discharges droplets of each material by pressure. As long as each discharge head is of inkjet type, the discharge head is not limited to the piezoelectric type and may be a type of discharge head in which each material is discharged by the pressure of a pump.

The UV light source 22 irradiates the model material discharged from the model material discharge head 16 and the support material discharged from the support material discharge head 20 with UV light to cure the materials. The UV light source 22 is selected according to the type of the model material and the support material. As the UV light source 22, for instance, a metal halide lamp, a high-pressure mercury lamp, an ultra-high pressure mercury lamp, a deep ultraviolet lamp, a mercury lamp which is excited from the outside without an electrode using microwave, an ultraviolet laser, a xenon lamp, or a device having a light source such as an UV-light emitting diode (LED) may be used. Furthermore, instead of the UV light source 22, an electron beam irradiation device may be used. As an electron beam irradiation device, for instance, a scanning-type, a curtain-type, and a plasma discharge type electron beam irradiation devices may be listed.

As illustrated in FIG. 2, the model material discharge head 16, the support material discharge head 20, and the UV light source 22 are mounted on a scanning shaft 24A included in the XY scanner 24.

The model material discharge head 16 (the model material discharge head 16T in the example of FIG. 2) disposed nearest to the UV light source 22, and the UV light source 22 are mounted on the scanning shaft 24A with a predetermined distance W spaced apart from each other. Also, the support material discharge head 20 adjacent to the model material discharge head 16 is mounted on the scanning shaft 24A. It is to be noted that the order of arrangement of the model material discharge head 16 and the support material discharge head 20 is not limited to the example illustrated in FIG. 2, and may be the other order of arrangement.

The XY scanner 24 drives the scanning shaft 24A so that the model material discharge head 16, the support material discharge head 20, and the UV light source 22 move in the X-axis direction and the Y-axis direction, in other words, scan the XY plane.

The model table lifter 26 moves up and down a model table 36 illustrated in FIG. 2 in the Z-axis direction. The CPU 12A controls the model material discharge head 16, the support material discharge head 20, and the UV light source 22 so that when a three-dimensional model is created, the model material and the support material are discharged onto the model table 36, and the discharged model material and support material is irradiated with UV light. The CPU 12A controls the XY scanner 24 so that the model material discharge head 16, the support material discharge head 20, and the UV light source 22 scan the XY plane, as well as controls the model table lifter 26 so that the model table 36 is gradually lowered in the Z-axis direction.

It is to be noted that when a three-dimensional model is created, in order to avoid contact between the model material discharge head 16, the support material discharge head 20, the UV light source 22, and a three-dimensional model 40 on the model table 36, the CPU 12A controls the model table lifter 26 so that the distance between the model material discharge head 16, the support material discharge head 20, the UV light source 22, and the three-dimensional model 40 on the model table 36 in the direction of the Z-axis is greater than or equal to a predetermined distance h0.

The cleaner 28 has the function of cleaning the nozzles of the model material discharge head 16 and the support material discharge head 20 by sucking material adhering to the nozzles. For instance, the cleaner 28 is provided in a retreat area outside a scan range of the model material discharge head 16 and the support material discharge head 20, and when cleaning is performed, the model material discharge head 16 and the support material discharge head 20 are retreated to the above-mentioned retreat area before cleaning.

The memory 30 stores the later-described three-dimensional modeling program 30A, three-dimensional modeling data 30B, and support material data 30C. The CPU 12A reads and executes the three-dimensional modeling program 30A stored in the memory 30. It is to be noted that by using a CD-ROM drive or the like, the CPU 12A may read and execute the three-dimensional modeling program 30A recorded on a recording medium such as a compact disk read only memory (CD-ROM). Also, the CPU 12A may read the three-dimensional modeling program 30A from an external device via a network to execute the three-dimensional modeling program 30A.

The communicator 32 is an interface for performing data communication with an external device that outputs three-dimensional model data of a three-dimensional model. The CPU 12A creates a three-dimensional model by controlling each of components in accordance with the three-dimensional modeling data 30B that is generated based on three-dimensional model data transmitted from an external device.

The remaining amount detector 34 individually detects the remaining amount of the model material stored in each model material storage 14, using an optical sensor, for instance.

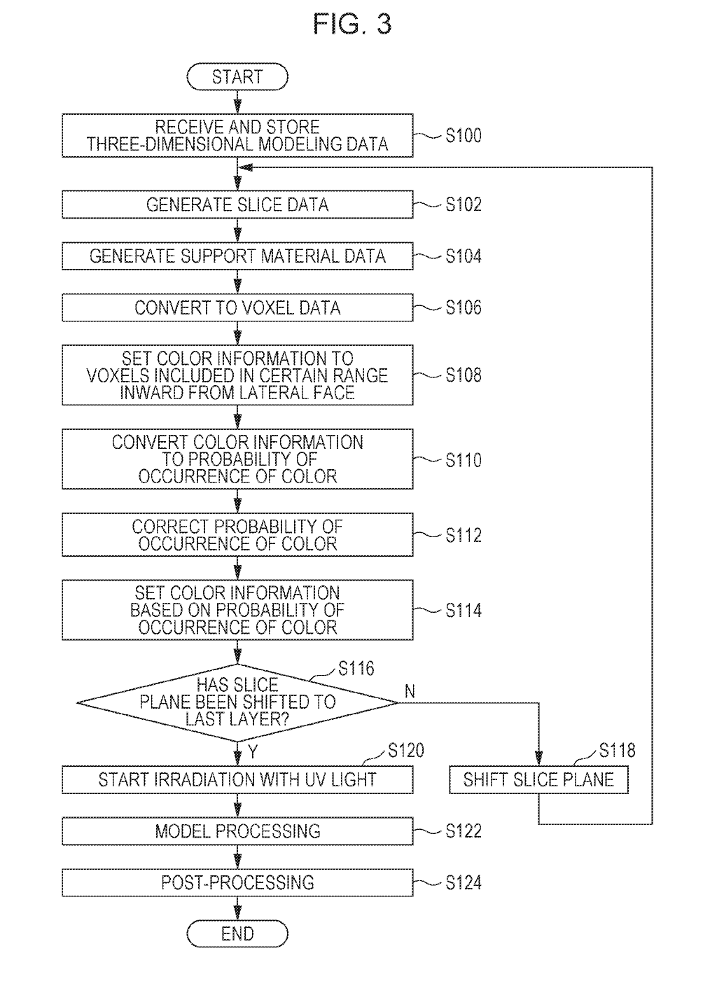

Next, the operation of the three-dimensional modeling apparatus 10 according to this exemplary embodiment will be described with reference to FIG. 3. The CPU 12A executes the three-dimensional modeling program 30A, thereby performing the three-dimensional model processing illustrated in FIG. 3. It is to be noted that the three-dimensional model processing illustrated in FIG. 3 is executed, for instance, when a command to start creating a three-dimensional model is received from an external device.

In step S100 of FIG. 3, three-dimensional model data of a three-dimensional model is received from an external device, and is stored in the memory 30.

As the format for three-dimensional modeling data, for instance, OBJ format is used which is a format for data that represents the shape and color of a three-dimensional model. In the OBJ format, an OBJ file that deals with data of geometric shapes, and an MTL file that deals with material data including color information and texture information are used. In this case, the three-dimensional model is represented by a set of triangular meshes, as an example. In the OBJ file, for each mesh, the face number specific to the mesh and the coordinate data of the vertices of the triangular mesh are defined associated with the mesh. Also, in the MTL file, color information and texture (pattern) information are defined in association with each mesh. It is to be noted that the format of data representing a three-dimensional model is not limited to the OBJ format, and may be another format.

In step S102, slice data is generated based on the three-dimensional model data. First, a slice plane parallel to a contact plane (XY plane) on which the three-dimensional model is in contact with the model table 36 is set. At first, a slice plane is set, for example, to the top layer of the three-dimensional model.

Slice data, which is obtained by slicing the three-dimensional model represented by the OBJ file using the set slice plane, is generated. The generated slice data represents the contour line of the set slice plane.

In step S194, the support material data 30C is generated and stored in the memory 30. A three-dimensional model is created by successively layering the model material on the model table 36. When a portion of the three-dimensional model has a space therebelow, that is, so-called an overhanging portion is present, the overhanging portion has to be supported from a lower position. For this reason, a support portion, which is a space below the overhang portion, is identified based on the slice data of the adjacent layer immediately above the layer which is the current target for processing, and the support material data 30C is generated. For instance, in the case of the three-dimensional model 40 as illustrated in FIG. 2, the space below an overhang portion is identified as a support portion 42, and the support material data 30C is generated, which indicates that the support material is to be discharged to the support portion 42.

Specifically, in the adjacent layer immediately above the layer which is the current target for processing, an area in which a three-dimensional model is present or an area for which the support material is determined to be necessary, in other words, the same area on the XY plane as the area, in which the model material or the support material is present, is identified as the support portion for which the support material is necessary for supporting the area in which the material of the upper layer is present. The support material data 30C is then generated, which indicates that the support material is to be discharged to the support portion.

In step S106, the slice data generated in step S102 and the support material data 30C generated in step S104 are converted to voxel data which is stored in the memory 30 as the three-dimensional modeling data 30B. The voxel data is such that a three-dimensional model is represented by voxels in a predetermined shape such as a rectangular parallelepiped. Thus, in step S106, the region surrounded by the contour line which is represented by the slice data generated in step S102, and the support portion represented by the support material data 30C generated in step S104 are divided into multiple voxels.

In step S108, the MTL file is referred to, and color information is set to each of the voxels included at the position of the contour line represented by the slice data generated in step S102, that is, in a predetermined certain range on the XY plane inward from a lateral side of the three-dimensional model.

In step S110, for each pixel, that is, for each voxel, the color information is converted into a color appearance probability.

First, the color information (r, g, b) of each pixel is converted into (c, m, y, k) by performing the calculation of the following Expressions (1) to (7) successively.

c=1−r (1)

m=1−g (2)

y=1−b (3)

k=min(c,m,y) (4)

c=c−k (5)

m=m−k (6)

y=y−k (7)

Subsequently, (c, m, y, k) is converted into color appearance probability (p_{c}, pₘ, p_{y}, pₖ, p_{w}). Specifically, each value of p_{c} to p_{w} is calculated by the following Expressions so that p_{c}+pₘ+p_{y}+pₖ+p_{w}=1.

p_{w}=(1−x_{c})×(1−xₘ)×(1−x_{y})×(1−xₖ) (8)

pn=(1−p_{w})×{xn/(x_{c}+xₘ+x_{y}+xₖ)} (9)

Here, in this exemplary embodiment, c, m, y, k are each 8 bit (0 to 255) data as an example. Also, xₙ=Dₙ/255, n represents any of c, m, y, k, and Dₙ represents the pixel value of n.

Subsequently, a color appearance probability pₜ of transparent color is calculated by the following Expressions.

pₜ=1−d/d₀(0≤d≤d₀) (10)

pₜ=0(d>d₀) (11)

Here, d represents the distance to a voxel (the position of a voxel) on the XY plane in an inward direction from a lateral side of the three-dimensional model. Also, do represents the distance to an end of a colored portion on the XY plane in an inward direction from a lateral side. It is to be noted that the distances d, d₀ are specifically represented by the number of voxels.

That is, for each pixel in a colored portion, the color appearance probability pₜ of transparent color is calculated by the Expression (10), and the region other than the colored portion, that is, for each pixel in a solid portion, the color appearance probability pₜ of transparent color is 0 by the Expression (11). It is to be noted that as an example, white is set to each voxel in the solid portion. However, a color other than white may be set to the voxel.

In step S112, for each voxel, the color appearance probability pn calculated in step S110 is corrected by the following Expressions.

pn=pn×d/d₀(0≤d≤d₀) (12)

pn=0(d>d₀) (13)

Here, n represents any of c, m, y, k, w, and pₜ+p_{c}+pₘ+p_{y}+pₖ+p_{w}=1.

In step S114, for each voxel, a color is set based on the color appearance probability, and the voxel data is stored in the memory 30 as the three-dimensional modeling data 30B. In this exemplary embodiment, as an example, uniform random numbers between 0 to 1 are generated, and one color of T, C, M, Y, K, and W is set to a voxel based on the generated uniform random numbers and the color appearance probabilities (pₜ, p_{c}, pₘ, p_{y}, pₖ, p_{w}).

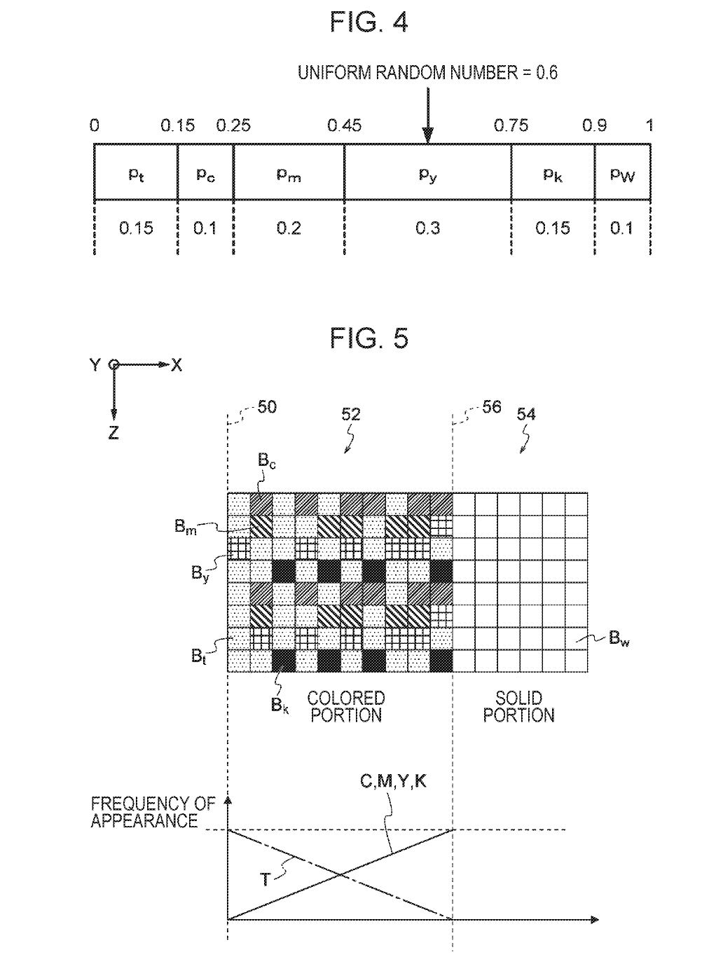

Specifically, as illustrated in FIG. 4, the range of 0 to 1 is divided according to the magnitudes of the color appearance probabilities (pₜ, p_{c}, pₘ, p_{y}, pₖ, p_{w}). The example of FIG. 4 is for the case where pₜ=0.15, p_{c}=0.1, pₘ=0.2, p_{y}=0.3, pₖ=0.15, and p_{w}=0.1.

Then, a color corresponding to the generated uniform random number is set to the voxel. For instance, when the uniform random number is 0.6 in the case of FIG. 4, yellow is set to the voxel.

In step S116, it is determined whether or not the slice plane has been shifted to the last layer, that is, the lowermost layer. When the slice plane has not been shifted to the lowermost layer, in other words, when an unprocessed slice plane is present, the flow proceeds to step S118, and when the slice plane has been shifted to the lowermost layer, the flow proceeds to step S120.

In step S118, the slice plane is shifted downward by a predetermined layer pitch (distance) p, and the flow proceeds to step S102.

Execution of the above-described processing to the lowermost layer generates the three-dimensional modeling data 30B such that the probability of discharge of the model material in transparent color is higher at a position closer to the lateral side of the three-dimensional model. The three-dimensional modeling data 30B is then stored in the memory 30. It is to be noted that the processing in steps S100 to S118 is an example of the three-dimensional modeling data generation program.

The upper side of FIG. 5 illustrates a color arrangement example in a lateral side section of the three-dimensional model, and the lower side of FIG. 5 illustrates the frequency of appearance of each color by a graph. When the color appearance probability pₜ of transparent color is calculated by the Expression (10), as illustrated in FIG. 5, between a lateral side 50 and a boundary 56 between a colored portion 52 and a solid portion 54, the frequency of appearance T of voxel Bt in a transparent color is lower at a position closer to the boundary 56.

In contrast, when the color appearance probability pn of each color is calculated by the Expression (12), as illustrated in FIG. 5, between the lateral side 50 and the boundary 56, the frequencies of appearance C, M, Y, and K of the voxels Bc, Bm, By, and Bk for c, m, y, and k are higher at a position closer to the boundary 56.

When the voxel Bt of transparent color is not set to the colored portion 52, a creation position, that is, a landed position of the model material of each color is displaced, and a specific model material may drop off from the lateral side during creation of the three-dimensional model.

In contrast, in this exemplary embodiment, the probability of discharge of the model material in transparent color is higher at a position closer to the lateral side of the three-dimensional model, and thus even when the creation position of each color other than the transparent color is displaced, the possibility of dropping off from the lateral side of the model material of each color other than the transparent color is reduced.

In step S120, the UV light source 22 is controlled to start irradiation with UV light.

In step S122, model processing is performed. Specifically, the XY scanner 24 is controlled so that the model material discharge head 16 and the support material discharge head 20 scan the XY plane, and the model table lifter 26 is controlled so that the model table 36 is gradually lowered in the Z-axis direction. Along with this control, the model material discharge head 16 is controlled in accordance with the three-dimensional modeling data 30B generated in step S114 so that the model material of each color is discharged, and the support material discharge head 20 is controlled so that the support material is discharged.

In step S134, predetermined post-processing is performed, such as processing of stopping irradiation with UV light started in step S120, and processing of cleaning the model material discharge head 16 and the support material discharge head 20. It is to be noted that the processing of cleaning may be performed at predetermined timing, for instance, every elapse of a predetermined period or every time when a predetermined amount of at least one of the model material and the support material is consumed. When the processing in step S124 is completed, the three-dimensional model processing is completed.

In this manner, in this exemplary embodiment, at a position closer to the lateral side of the three-dimensional model, the probability of discharge of the model material in transparent color is higher, and the probability of discharge of the model material in each color other than the transparent color is lower. Therefore, even when the creation position of each color other than the transparent color is displaced, the possibility of dropping off from the lateral side of the model material of each color other than the transparent color is reduced.

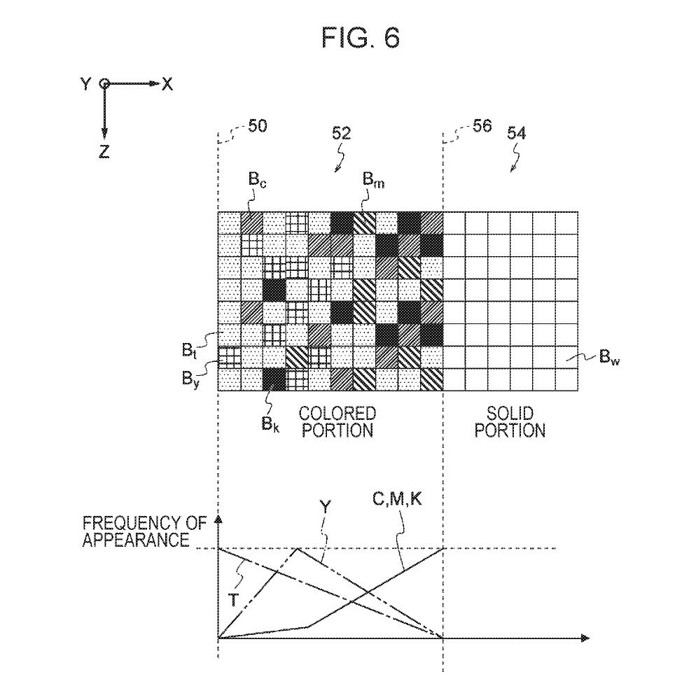

It is to be noted that in this exemplary embodiment, as illustrated in FIG. 5, a case has been described, in which the frequencies of appearance of C, M, Y, and K other than the transparent color have the similar characteristics. However, without being limited to this, for instance, the model material of each color other than the transparent color may be discharged in the order of less visibility of color inwardly from the lateral side. Specifically, as illustrated in FIG. 6, Expression (12) may be set so that the frequency of appearance on the lateral side of the least visible color Y between C, M, Y, and K is higher than the frequency of appearance of each color other than Y. Thus, the least visible color yellow is arranged with a higher appearance, and thus displacement of a creation position is more difficult to be recognized.

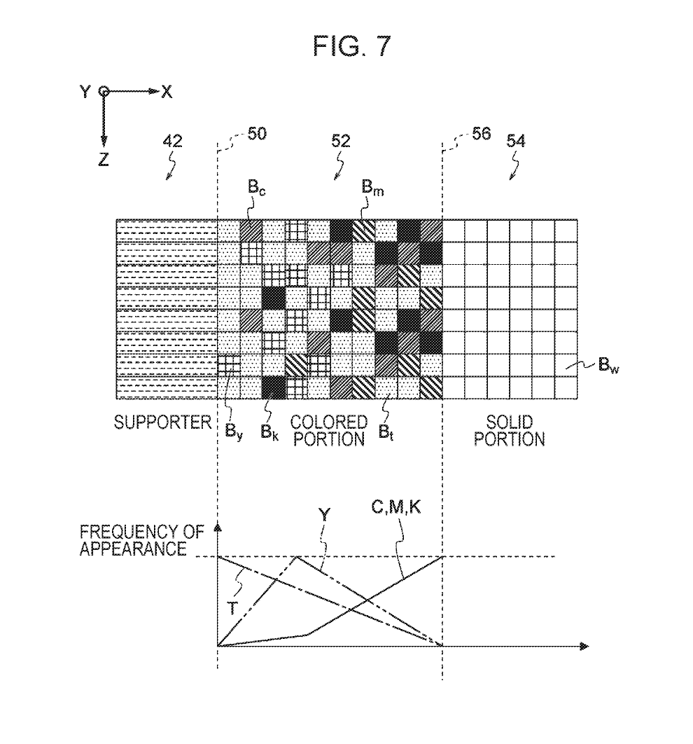

Also, as illustrated in FIG. 7, the support material may be formed by discharging the support material on the lateral side of the colored portion 52. Thus, the possibility of dropping off from the lateral side of the model material of each color is further reduced.

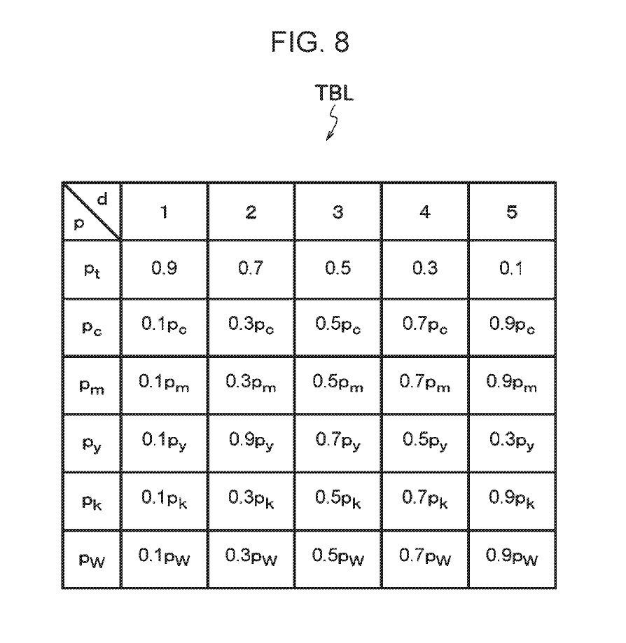

Also, in this exemplary embodiment, the color appearance probability of each color in the colored portion 52 is corrected by the Expressions (10), (12) in step S112 of FIG. 4. However, the color appearance probability of each color may be corrected using the table data TBL illustrated in FIG. 8. The table data TBL illustrated in FIG. 8 provides data that indicates a correspondence between the distance d (in terms of the number of voxels) in an inward direction from the lateral side, and color appearance probabilities pₜ to p_{w}. It is to be noted that the table data TBL illustrated in FIG. 8 is an example for the case where the distance d₀ is 5 (voxels).

For instance, when the distance d is 2, the color appearance probability p_{y} is 0.9 p_{y}. This indicates that the color appearance probability p_{y} is replaced by 0.9 p_{y}. The table data TBL is defined such that when the distance d is 2, the concentration of Y is maximized.

In step S114, it is sufficient that one color of T, C, M, Y, K, and W is set to the voxel using a uniform random number that maximizes the sum of the color appearance probabilities (pₜ, p_{c}, pₘ, p_{y}, pₖ, p_{w}).

Also, in this exemplary embodiment, the case has been described, in which at a position closer to the lateral side of the three-dimensional model, the probability of discharge of the model material in the transparent color is higher, and the probability of discharge of the model material in each color other than the transparent color is lower. However, an attribute other than color, for instance, hardness, a drop size of the model material may be applied to the invention.

For instance, at a position closer to the lateral side of the three-dimensional model, the probability of discharge of a model material with predetermined hardness may be higher, and the probability of discharge of a model material softer than predetermined hardness may be lower. For instance, when the rate of use of the hardest model material among the model materials to be used is higher at a position closer to the lateral side of the three-dimensional model, the three-dimensional model has a hard surface. Also, when the rate of use of the softest model material among the model materials to be used is higher at a position closer to the lateral side of the three-dimensional model, the three-dimensional model has a hard surface.

Also, at a position closer to the lateral side of the three-dimensional model, the probability of discharge of a model material having a predetermined drop size may be higher, and the probability of discharge of a model material having a drop size larger than a predetermined drop size may be lower. For instance, when the probability of discharge of a model material having the smallest drop size among the model materials to be used is higher at a position closer to the lateral side of the three-dimensional model, the three-dimensional model has a smooth surface.

Also, when the shape of the three-dimensional model on the lateral side is a vertical shape or an overhang shape, the probability of discharge of a model material having a predetermined attribute may be higher at a position closer to the lateral side of the three-dimensional model.

Also, when the shape of the three-dimensional model on the lateral side is not a vertical shape or an overhang shape, the probability of discharge of a model material having a predetermined attribute may not be higher at a position closer to the lateral side of the three-dimensional model. Consequently, consumption of a model material having a predetermined attribute is reduced.

In this exemplary embodiment, an inkjet type three-dimensional modeling apparatus has been described. However, without being limited to this, the present invention may be applied to a three-dimensional modeling apparatus using fused deposition modeling (FDM).

Although the case has been described in which the model table 36 is gradually lowered in the Z-axis direction while the XY plane is being scanned by the model material discharge head 16 in the aforementioned exemplary embodiment, the model table 36 may be fixed and the model table 36 may be gradually raised in the Z-axis direction while the XY plane is being scanned by the model material discharge head 16. Also, the model material discharge head 16 and the model table 36 may be moved away in the Z-axis direction.

Also, the configuration of the three-dimensional modeling apparatus 10 (see FIG. 1) described in the aforementioned exemplary embodiment is an example, and it goes without saying that an unnecessary portion may be eliminated or a new portion may be added within a scope not departing from the spirit of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A three-dimensional modeling apparatus comprising:
a plurality of discharge heads that is used for model processing of a three-dimensional model, and that discharges a plurality of model materials with different attributes; and
a controller that controls the plurality of discharge heads so that a probability of discharge of a model material with a predetermined attribute is higher at a position closer to a lateral side of the three-dimensional model.

2. The three-dimensional modeling apparatus according to claim 1,
wherein the plurality of discharge heads includes a first discharge head that discharges a coloring material, and a second discharge head that discharges a transparent material, and
the controller controls the first discharge head and the second discharge head so that a probability of discharge of the transparent material is higher at a position closer to the lateral side of the three-dimensional model.

3. The three-dimensional modeling apparatus according to claim 2,
wherein the first discharge head is provided for each of a plurality of colors, and
the controller controls a plurality of first discharge heads including the first discharge head so that coloring materials for the plurality of colors are discharged in an order of less visibility of color inwardly from the lateral side.

4. The three-dimensional modeling apparatus according to claim 1,
wherein the plurality of discharge heads each includes a support material discharge head that discharges a support material, and
the controller controls the support material discharge head so that the support material is discharged to the lateral side of the three-dimensional model.

5. The three-dimensional modeling apparatus according to claim 2,
wherein the plurality of discharge heads each includes a support material discharge head that discharges a support material, and
the controller controls the support material discharge head so that the support material is discharged to the lateral side of the three-dimensional model.

6. The three-dimensional modeling apparatus according to claim 3,
wherein the plurality of discharge heads each includes a support material discharge head that discharges a support material, and
the controller controls the support material discharge head so that the support material is discharged to the lateral side of the three-dimensional model.

7. The three-dimensional modeling apparatus according to claim 1,
wherein the controller controls the plurality of discharge heads so that a probability of discharge of a model material with predetermined hardness is higher at a position closer to the lateral side of the three-dimensional model.

8. The three-dimensional modeling apparatus according to claim 1,
wherein the controller controls the plurality of discharge heads so that a probability of discharge of a model material having a predetermined drop size is higher at a position closer to the lateral side of the three-dimensional model.

9. The three-dimensional modeling apparatus according to claim 1,
wherein when a shape of the three-dimensional model on the lateral side is a vertical shape or an overhang shape, the controller controls the plurality of discharge heads so that the probability of discharge of the model material with the predetermined attribute is higher at a position closer to the lateral side of the three-dimensional model.

10. The three-dimensional modeling apparatus according to claim 2,
wherein when a shape of the three-dimensional model on the lateral side is a vertical shape or an overhang shape, the controller controls the plurality of discharge heads so that the probability of discharge of the model material with the predetermined attribute is higher at a position closer to the lateral side of the three-dimensional model.

11. The three-dimensional modeling apparatus according to claim 3,
wherein when a shape of the three-dimensional model on the lateral side is a vertical shape or an overhang shape, the controller controls the plurality of discharge heads so that the probability of discharge of the model material with the predetermined attribute is higher at a position closer to the lateral side of the three-dimensional model.

12. The three-dimensional modeling apparatus according to claim 4,
wherein when a shape of the three-dimensional model on the lateral side is a vertical shape or an overhang shape, the controller controls the plurality of discharge heads so that the probability of discharge of the model material with the predetermined attribute is higher at a position closer to the lateral side of the three-dimensional model.

13. The three-dimensional modeling apparatus according to claim 5,
wherein when a shape of the three-dimensional model on the lateral side is a vertical shape or an overhang shape, the controller controls the plurality of discharge heads so that the probability of discharge of the model material with the predetermined attribute is higher at a position closer to the lateral side of the three-dimensional model.

14. The three-dimensional modeling apparatus according to claim 6,
wherein when a shape of the three-dimensional model on the lateral side is a vertical shape or an overhang shape, the controller controls the plurality of discharge heads so that the probability of discharge of the model material with the predetermined attribute is higher at a position closer to the lateral side of the three-dimensional model.

15. The three-dimensional modeling apparatus according to claim 7,
wherein when a shape of the three-dimensional model on the lateral side is a vertical shape or an overhang shape, the controller controls the plurality of discharge heads so that the probability of discharge of the model material with the predetermined attribute is higher at a position closer to the lateral side of the three-dimensional model.

16. The three-dimensional modeling apparatus according to claim 8,
wherein when a shape of the three-dimensional model on the lateral side is a vertical shape or an overhang shape, the controller controls the plurality of discharge heads so that the probability of discharge of the model material with the predetermined attribute is higher at a position closer to the lateral side of the three-dimensional model.

17. A non-transitory computer readable medium storing a three-dimensional modeling program causing a computer to execute a process, the process comprising
controlling a plurality of discharge heads that is used for model processing of a three-dimensional model, and that discharges a plurality of model materials with different attributes so that a probability of discharge of a model material with a predetermined attribute is higher at a position closer to the lateral side of the three-dimensional model.

18. A non-transitory computer readable medium storing a three-dimensional modeling data generation program causing a computer to execute a process, the process comprising
generating three-dimensional modeling data in which a probability of discharge of a model material with a predetermined attribute is higher at a position closer to a lateral side of a three-dimensional model.
